(19) United States
(12) Patent Application Publication
(10) Pub. No.: US 2025/0225399 A1
(43) Pub. Date: Jul. 10, 2025

(54) ANOMALY DETECTION BASED ON A SCORING FUNCTION DERIVED USING NORMALIZING FLOWS

(71) Applicant: ThetaRay Ltd., Hod HaSharon (IL)

(72) Inventor: David Segev, Hod HaSharon (IL)

(21) Appl. No.: 18/986,746

(22) Filed: Dec. 19, 2024

Related U.S. Application Data
(60) Provisional application No. 63/619,347, filed on Jan. 10, 2024.

(51) Int. Cl. G06N 3/084

(52) U.S. Cl. CPC G06N 3/084

(57) ABSTRACT

A computer program product and computer system configured to perform a method including: receiving input data including a multidimensional data point (MDDP), deriving a scoring function using normalizing flows (NF), and using the scoring function to provide a probability of whether the MDDP is normal or is an anomaly.

### CROSS REFERENCE TO EXISTING APPLICATIONS

This application claims priority from U.S. Provisional Patent Application No. 63/619,347 filed Jan. 10, 2024, which is incorporated herein by reference in its entirety.

### FIELD

Embodiments disclosed herein relate in general to methods and systems for detection of anomalies and in particular to derivation of a scoring function via normalizing flows for detection of anomalies which are indicative of an undesirable event among multidimensional data points (MDDPs) of tabular data by an unsupervised method.

### BACKGROUND

Huge amounts of data are generated by many sources. “Data”, which also includes tabular data, refers to a collection of information, the result of experience, observation, measurement, streaming, computing, sensing or experiment, other information within a computer system, or a set of premises that may consist of numbers, characters, images, or as measurements of observations.

Static and dynamic “high dimensional big data” (HDBD) are common in a variety of fields. Exemplarily, such fields include finance, energy, medicine, transportation, communication networking (i.e., protocols such as TCP/IP, UDP, HTTP, HTTPS, ICMP, SMTP, DNS, FTPS, SCADA, wireless and Wi-Fi) streaming, IoT (identifying problematic operations in devices/machines such as batteries, turbines, measurements), predictive maintenance, process control and predictive analytics, social networking, imaging, e-mails, governmental databases, industrial data, healthcare and aviation.

HDBD is a collection of multi-dimensional data points (MDDPs). An MDDP, also referred to as “data sample”, “sampled data”, “data point”, “vector of observations”, “vector of transactions” or “vector of measurements”, is one unit of data from the original (source, raw) HDBD. An MDDP may be expressed as a combination of numeric, Boolean, integer, floating, binary or real characters. HDBD datasets (or databases) include MDDPs that may be either static or may accumulate constantly (dynamic). MDDPs may include (or may be described by) hundreds or thousands of parameters (or “features”).

The terms “parameter” or “feature” refer to an individual measurable property of phenomena being observed. A feature may also be “computed”, i.e., be an aggregation of different features to derive an average, a median, a standard deviation, etc. “Feature” is also normally used to denote a piece of information relevant for solving a computational task related to a certain application. More specifically, “features” may refer to specific structures ranging from simple structures to more complex structures such as objects. The feature concept is very general and the choice of features in a particular application may be highly dependent on the specific problem at hand. Features can be described in numerical (3.14), Boolean (yes, no), ordinal (never, sometimes, always), or categorical (A, B, O) manner.

If source (“original” or “raw”) data is described for example by 25 measured parameters (“features”) that are sampled (recorded, measured) in every predetermined time interval (e.g., every minute), then the data is of any dimension. Multi-dimensional data is a collection of datapoints.

There are various methods for detection of anomalies among multidimensional data points (MDDPs) in an unsupervised way, which means that normal and anomalous data points are unknown but their performances related to detection rate and false alarms are unsatisfactory. However, the demand for such methods remains high, and new, improved methods are constantly sought. In particular, it would be desirable to have automatic and unsupervised anomaly detection methods and associated systems characterized by not having or using domain expertise, signatures, rules, patterns or semantics understanding of all the available features.

### SUMMARY

Embodiments disclosed herein relate to the derivation of a scoring function that may assign a score to each MDDP that indicates whether this MDDP is normal or anomalous (abnormal) by using normalizing flows (NF). For convenience hereinafter, an MDDP may also be referred to as an “element” and/or a “data element”. A detected anomaly may be indicative of an undesirable event that deviates from normality.

In this description, an “undesirable event” indicated by an anomaly or by an abnormal MDDP” may be, for example, any of (but not limited to) a cyber-threat, a cyber-attack, an operational malfunction, an operational breakdown, a process malfunction, predictive maintenance, a process breakdown, a financial crime, a financial risk event, a financial threat event, a financial fraud event, or a financial network intrusion event.

There is described herein a method and a system for detection of anomalies in HDBD by the derivation of a scoring function which is indicative of undesirable events that are either unknown, which may be referred to as “unknown undesirable events”, and given anomalies which are known. Use of unknown anomalies may be associated with an unsupervised approach.

Normalizing flows (NF) (Kobyzev, Ivan, Simon JD Prince, and Marcus A. Brubaker. “Normalizing flows: An introduction and review of current methods.” IEEE transactions on pattern analysis and machine intelligence 43.11 (2020): 3964-3979), are generative models which produce tractable distributions where both sampling and density evaluation can be efficient and exact. NF, which is a generative model, learns the probability density function p(x) of the real input data. It models the true data distribution p(x) while providing an exact likelihood estimate.

Flows of NF use invertible functions ƒ to map the input data x to a latent representation z. However, an invertible mapping also means that for every datapoint, there is a corresponding latent representation which enables performance of lossless reconstruction (z to x). NF assumes that the samples x, which have no known distribution, are drawn from a latent variable z with a known normal distribution. The representation of x by the latent space of z may be found by applying a series of transformations (a flow) to the data. Specifically, given a random variable z and its known probability density function z˜q(z), it is desirable to construct a new random variable using a 1-1 mapping function x=ƒ(z). Inferring of an unknown probability density function of a new variable p(x) and NF model of a probability density with an invertible function are explained further below.

Given a prior density q(z) (e.g., z is Gaussian) and an invertible function ƒ, p(x) may be determined as described below.

To detect anomalies in the data, we can look at it as a way to calculate the likelihood of a sample x without knowing its distribution by calculating the likelihood of z.

Consistent with disclosed embodiments, a computer program product may include: a non-transitory tangible storage medium readable by a processing circuit and storing instructions for execution by the processing circuit for performing a method including: receiving input data including a multidimensional data point (MDDP), deriving a scoring function using normalizing flows (NF), and using the scoring function to provide a probability of whether the MDDP is normal or is an anomaly.

In some embodiments, the deriving includes computation of a Jacobian matrix and the computation is accelerated by calculating only the determinant of the Jacobian matrix including forcing the Jacobian to be triangular. In some embodiments, the deriving a scoring function includes a training phase, wherein, for a data sample x and K affine cells, the training phase includes: for k=1 to K or k≤K iterations: dividing x into xᵤₚ and x_{down}; calculating the feed forward output of a first two independent neural networks (NNs) s_{down}^{(k)}=tanh(wₛ₋ᵤₚ^{(k)}xᵤₚ+bₛ₋ᵤₚ^{(k)}) and t_{down}^{(k)}=tanh(wₜ₋ᵤₚ^{(k)}xᵤₚ+bₜ₋ᵤₚ^{(k)}) where b and w are the first biases and weights of the first two independent NNs; calculating y_{down}=s_{down}^{(k)}⊙x_{down}+t_{down}^{(k)} and defining yᵤₚ=xᵤₚ; calculating a feed forward output of a second two independent NNs sᵤₚ^{(k)}=tanh(w_{s-down}^{(k)}y_{down}+b_{s-down}^{(k)}) and tᵤₚ^{(k)}=tanh(w_{t-down}^{(k)}y_{down}+b_{t-down}^{(k)}); calculating zᵤₚ=sᵤₚ^{(k)}⊙yᵤₚ+tᵤₚ^{(k)}, defining z_{down}=y_{down}; defining z=[zᵤₚ, z_{down}] and x=z for the next iteration; and incrementing K=k+1, wherein for k=K: calculating a loss function of the NNs; and applying back propagation to train the weights and biases of the NNs.

In some embodiments, the deriving a scoring function includes, using an output of the training phase and the MDDP (x_{MDDP}) as inputs: for k=1 to K or k≤K iterations: dividing x_{MDDP} into xᵤₚ and x_{down}, calculating s_down and t_down according to s_{down}^{(k)}=tanh(wₛ₋ᵤₚ^{(k)}xᵤₚ+bₛ₋ᵤₚ^{(k)}) and t_{down}^{(k)}=tanh(wₜ₋ᵤₚ^{(k)}xᵤₚ+bₜ₋ᵤₚ^{(k)}) using b and w determined in the training phase; calculating y_{down}=s_{down}^{(k)}⊙x_{down}+t_{down}^{(k)}; defining yᵤₚ=xᵤₚ; calculating sᵤₚ^{(k)}=tanh(w_{s-down}^{(k)}y_{down}+b_{s-down}^{(k)}) and tᵤₚ^{(k)}=tanh(w_{t-down}^{(k)}y_{down}+b_{t-down}^{(k)}) using b and w determined in the training phase; calculating zᵤₚ=sᵤₚ^{(k)}⊙yᵤₚ+tᵤₚ^{(k)}; defining z_{down}=y_{down}; defining x=z for the next iteration; incrementing K=k+1, wherein for k=K: calculating a loss function to generate a score for the MDDP.

In some embodiments, the returned score is used to determine whether the MDDP is normal or is an anomaly. In some embodiments, the method further may include: when the MDDP is classified as an anomaly, performing one or more of triggering an alarm, and sending a notification to a user or a data client system, wherein classification of the MDDP as an anomaly is indicative of detection of an unknown undesirable event.

Consistent with disclosed embodiments, a computer system may include: a hardware processor configurable to perform a method including: receiving input data including a multidimensional data point (MDDP), deriving a scoring function using normalizing flows (NF), and using the scoring function to provide a probability of whether the MDDP is normal or is an anomaly.

In some embodiments, the deriving includes computation of a Jacobian matrix and the computation is accelerated by calculating only the determinant of the Jacobian matrix including forcing the Jacobian to be triangular. In some embodiments, the deriving a scoring function includes a training phase, wherein, for a data sample x and K affine cells, the training phase includes: for k=1 to K or k≤K iterations: dividing x into xᵤₚ and x_{down}; calculating the feed forward output of a first two independent neural networks (NNs) s_{down}^{(k)}=tanh(wₛ₋ᵤₚ^{(k)}xᵤₚ+bₛ₋ᵤₚ^{(k)}) and t_{down}^{(k)}=tanh(wₜ₋ᵤₚ^{(k)}xᵤₚ+bₜ₋ᵤₚ^{(k)}) where b and w are the first biases and weights of the first two independent NNs; calculating y_{down}=s_{down}^{(k)}⊙x_{down}+t_{down}^{(k)} and defining yᵤₚ=xᵤₚ; calculating a feed forward output of a second two independent NNs sᵤₚ^{(k)}=tanh(w_{s-down}^{(k)}y_{down}+b_{s-down}^{(k)}) and tᵤₚ^{(k)}=tanh(w_{t-down}^{(k)}y_{down}+b_{t-down}^{(k)}); calculating zᵤₚ=sᵤₚ^{(k)}⊙yᵤₚ+tᵤₚ^{(k)}; defining z_{down}=y_{down}; defining z=[zᵤₚ, z_{down}] and x=z for the next iteration; and incrementing K=k+1, wherein for k=K: calculating a loss function of the NNs; and applying back propagation to train the weights and biases of the NNs.

In some embodiments, the deriving a scoring function includes, using an output of the training phase and the MDDP (x_{MDDP}) as inputs: for k=1 to K or k≤K iterations: dividing x_{MDDP} into xᵤₚ and x_{down}, calculating s_down and t_down according to s_{down}^{(k)}=tanh(wₛ₋ᵤₚ^{(k)}xᵤₚ+bₛ₋ᵤₚ^{(k)}) and t_{down}^{(k)}=tanh(wₜ₋ᵤₚ^{(k)}xᵤₚ+bₜ₋ᵤₚ^{(k)}) using b and w determined in the training phase; calculating y_{down}=s_{down}^{(k)}⊙x_{down}+t_{down}^{(k)}; defining yᵤₚ=xᵤₚ; calculating sᵤₚ^{(k)}=tanh(w_{s-down}^{(k)}y_{down}+b_{s-down}^{(k)}) and tᵤₚ^{(k)}=tanh(w_{t-down}^{(k)}y_{down}+b_{t-down}^{(k)}) using b and w determined in the training phase; calculating zᵤₚ=sᵤₚ^{(k)}⊙yᵤₚ+tᵤₚ^{(k)}; defining z_{down}=y_{down}; defining x=z for the next iteration; incrementing K=k+1, wherein for k=K: calculating a loss function to generate a score for the MDDP.

In some embodiments, the returned score is used to determine whether the MDDP is normal or is an anomaly. In some embodiments, the method may further include: when the MDDP is classified as an anomaly, performing one or more of triggering an alarm, and sending a notification to a user or a data client system, wherein classification of the MDDP as an anomaly is indicative of detection of an unknown undesirable event.

Consistent with disclosed embodiments, a method may include: receiving input data including a multidimensional data point (MDDP); deriving a scoring function using normalizing flows (NF); and using the scoring function to provide a probability of whether the MDDP is normal or is an anomaly.

In some embodiments, the deriving includes computation of a Jacobian matrix and the computation is accelerated by calculating only the determinant of the Jacobian matrix including forcing the Jacobian to be triangular. In some embodiments, the deriving a scoring function includes a training phase, wherein, for a data sample x and K affine cells, the training phase includes: for k=1 to K or k≤K iterations: dividing x into xᵤₚ and x_{down}; calculating the feed forward output of a first two independent neural networks (NNs) s_{down}^{(k)}=tanh(wₛ₋ᵤₚ^{(k)}xᵤₚ+bₛ₋ᵤₚ^{(k)}) and t_{down}^{(k)}=tanh(wₜ₋ᵤₚ^{(k)}xᵤₚ+bₜ₋ᵤₚ^{(k)}) where b and w are the first biases and weights of the first two independent NNs; calculating y_{down}=s_{down}^{(k)}⊙x_{down}+t_{down}^{(k)} and defining yᵤₚ=xᵤₚ; calculating a feed forward output of a second two independent NNs sᵤₚ^{(k)}=tanh(w_{s-down}^{(k)}y_{down}+b_{s-down}^{(k)}) and tᵤₚ^{(k)}=tanh(w_{t-down}^{(k)}y_{down}+b_{t-down}^{(k)}); calculating zᵤₚ=sᵤₚ^{(k)}⊙yᵤₚ+tᵤₚ^{(k)}; defining z_{down}=y_{down}; defining z=[zᵤₚ, z_{down}] and x=z for the next iteration; and incrementing K=k+1, wherein for k=K: calculating a loss function of the NNs; and applying back propagation to train the weights and biases of the NNs.

In some embodiments, the deriving a scoring function includes, using an output of the training phase and the MDDP (x_{MDDP}) as inputs: for k=1 to K or k≤K iterations: dividing x_{MDDP} into xᵤₚ and x_{down}; calculating s_down and t_down according to s_{down}^{(k)}=tanh(wₛ₋ᵤₚ^{(k)}xᵤₚ+bₛ₋ᵤₚ^{(k)}) and t_{down}^{(k)}=tanh(wₜ₋ᵤₚ^{(k)}xᵤₚ+bₜ₋ᵤₚ^{(k)}) using b and w determined in the training phase; calculating y_{down}=s_{down}^{(k)}⊙x_{down}+t_{down}^{(k)}; defining yᵤₚ=xᵤₚ; calculating sᵤₚ^{(k)}=tanh(w_{s-down}^{(k)}y_{down}+b_{s-down}^{(k)}) and tᵤₚ^{(k)}=tanh(w_{t-down}^{(k)}y_{down}+b_{t-down}^{(k)}) using b and w determined in the training phase; calculating zᵤₚ=sᵤₚ^{(k)}⊙yᵤₚ+tᵤₚ^{(k)}; defining z_{down}=y_{down}; defining x=z for the next iteration; incrementing K=k+1, wherein for k=K: calculating a loss function to generate a score for the MDDP.

In some embodiments, the returned score is used to determine whether the MDDP is normal or is an anomaly. In some embodiments, the method may further include: when the MDDP is classified as an anomaly, performing one or more of triggering an alarm, and sending a notification to a user or a data client system, wherein classification of the MDDP as an anomaly is indicative of detection of an unknown undesirable event.

An anomaly detection method and associated system disclosed herein is characterized by either not having or using domain expertise, signatures, rules, patterns or semantics understanding of all the available features, in other words, it is automatic and unsupervised or semi-supervised.

This Summary is provided to introduce a selection of concepts in a simplified form that are further described below in the Detailed Description below. It may be understood that this Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings.

### BRIEF DESCRIPTION OF THER DRAWINGS

For simplicity and clarity of illustration, elements shown in drawings are not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below;

FIG. 1 shows a block diagram of a system for detecting anomalies, according to some implementations;

FIG. 2 is a flow diagram of an example process for training input data for derivation of a NF model according to some implementations;

FIG. 3 is a flow diagram of an example process for derivation of a scoring function and use of the scoring function for anomaly detection according to some implementations.

### DETAILED DESCRIPTION

Reference will now be made in detail to non-limiting examples of anomaly detection systems and methods which are illustrated in the accompanying drawings. The examples are described below by referring to the drawings, wherein like reference numerals refer to like elements. When similar reference numerals are shown, corresponding description(s) are not repeated, and the interested reader is referred to the previously discussed figure(s) for a description of the like element(s).

Aspects of this disclosure may provide a technical solution to the challenging technical problem of anomaly detection and may relate to a system for providing anomaly detection with the system having at least one processor (e.g., processor, processing circuit or other processing structure described herein), including methods, systems, devices, and computer-readable media. For ease of discussion, example methods are described below with the understanding that aspects of the example methods apply equally to systems, devices, and computer-readable media. For example, some aspects of such methods may be implemented by a computing device or software running thereon. The computing device may include at least one processor (e.g., a CPU, GPU, DSP, FPGA, ASIC, or any circuitry for performing logical operations on input data) to perform the example methods. Other aspects of such methods may be implemented over a network (e.g., a wired network, a wireless network, or both).

As another example, some aspects of such methods may be implemented as operations or program codes in a non-transitory computer-readable medium. The operations or program codes may be executed by at least one processor. Non-transitory computer readable media, as described herein, may be implemented as any combination of hardware, firmware, software, or any medium capable of storing data that is readable by any computing device with a processor for performing methods or operations represented by the stored data. In a broadest sense, the example methods are not limited to particular physical or electronic instrumentalities, but rather may be accomplished using many differing instrumentalities.

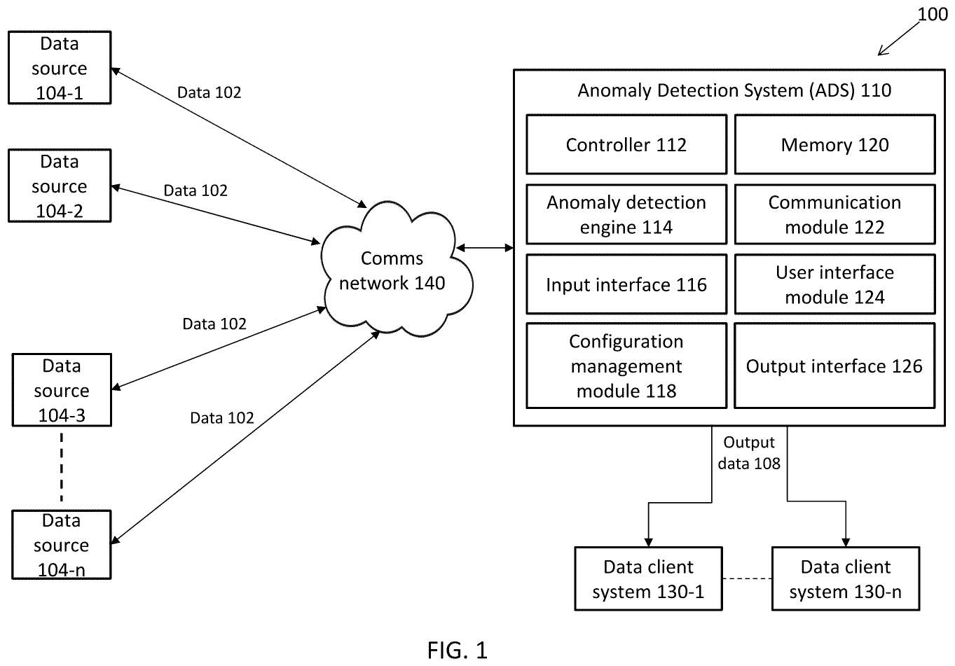

FIG. 1 shows a system 100 for detection of anomalies in data according to some implementations. As shown in FIG. 1, a system 100 for detection of anomalies in data may include an anomaly detection system (ADS) 110 configured to detect anomalies in data 102 provided to anomaly detection system 110. In some embodiments, data 102 may be provided from data sources 104 to anomaly detection system 100 for detection of anomalies. Data 102 may be of any suitable structure and format and the volume and span (number of parameters) of data 102 may be theoretically unlimited. In some embodiments, varying types and numbers of data sources 104 (shown in FIG. 1 as data source 104-1, 104-2, 104-3 . . . 104-n) may provide data 102. Non-limiting examples of data sources 104 may include networks, sensors, data warehouses, risk systems, audit systems, security events managements systems and/or process control equipment. Data 102 provided by data sources 104 may include but is not limited to, for example, historical data, financial data, sensor data, network traffic data, online data, streaming data, databases, production data and/or the like. Data 102 may include training datasets such as the training datasets used in process 200 described below. Training datasets may include known examples of anomalies to be used during a machine learning process such as process 200 when the processing is semi-supervised.

In some embodiments, data sources 104 may be in data communication with anomaly detection system 110 via communications network 140. Communications network 140 may include a wide variety of network configurations and protocols that facilitate the intercommunication of computing devices.

Anomaly detection system 110 may be a computing device as defined herein. Anomaly detection system 110 may be implemented on a server, distributed server, virtual server, cloud-based server, and combinations thereof and may make use of cloud and software as a service (SaaS) processing. Anomaly detection system 110 and the modules and components that are included in anomaly detection system 110 may include or may be in communication with a non-transitory computer readable medium (such as memory 120) containing instructions that when executed by at least one processor (such as controller 112) are configured to perform the functions and/or operations necessary to provide the functionality described herein. While anomaly detection system 110 is presented herein with specific components and modules, it should be understood by one skilled in the art, that the architectural configuration of anomaly detection system 110 as shown may be simply one possible configuration and that other configurations with more or fewer components are possible. As referred to herein, the “components” of anomaly detection system 110 may include one or more of the modules or services shown in FIG. 1 as being included within anomaly detection system 110.

Anomaly detection system 110 may include a controller 112. Controller 112 may manage the operation of the components of anomaly detection system 110 and may direct the flow of data between the components of anomaly detection system 110. Where anomaly detection system 110 may be said herein to provide specific functionality or perform actions, it should be understood that the functionality or actions are performed by controller 112 that may call on other components of anomaly detection system 110. Controller 112 may be implemented by various types of processor devices and/or processor architectures including, for example, embedded processors, communication processors, graphics processing unit (GPU), soft-core processors and/or embedded processors. In some embodiments, anomaly detection system 110 may include memory 120 that may include instructions which, when executed by controller 112 may cause the execution of a method or process described herein.

Anomaly detection system 110 may include an anomaly detection engine (ADE) 114. Methods, processes and/or operations for detecting anomalies may be implemented by anomaly detection engine 114. The term “engine” as used herein may also relate to and/or include a computer program module and/or a computerized application and/or one or more hardware, software, and/or hybrid hardware/software modules. Anomaly detection engine 114 may be configured to detect anomalies based on processes 200 and 300 disclosed herein.

In some embodiments, anomaly detection system 110 may include one or more input interfaces 116. Input interface 116 may be configured to ingest and format data 102 and/or 103 for use by anomaly detection engine 114. In some embodiments, anomaly detection system 110 may include a configuration management module 118 which may be configured to configure anomaly detection system 110 such as, for example, to optimize the results of and/or provide judgmental qualitative and quantitative measures on the operation of anomaly detection system 110.

In some embodiments, anomaly detection system 110 may include a communication module 122 for enabling the transmission and/or reception of data, optionally over communication network 140. Communication module 122 may be used for communicating a notification or alarm related to a detected anomaly. Communication module 122 may include human interface components (not shown) such as a display device for displaying information to a user and input devices such as a touch screen and/or a keyboard and a pointing device (e.g., a mouse or a trackball) by which the user can provide input to the computer. Alarms, notifications and warnings related to anomalies may be provided via the above human interface components.

In use, anomaly detection system 110 may filter data 102 and/or 103 to provide output data 108. In some embodiments, output data 108 may be descriptive of analysis results from anomaly detection engine 114. In some embodiments, output data 108 may include filtered input data, i.e., input data (102 or 103) which is free or substantially free of anomalies. In some embodiments, output data 108 may include an alarm or alarms. In some embodiments, output data 108 may include notifications about an anomaly or anomalies. In some embodiments, output data 108 may be provided to one or more data client systems 130 (shown in FIG. 1 as data client systems 130-1, 130-2). Data client systems 130 may include computing devices as defined herein. In some embodiments, output data 108 may be provided to data client systems 130 using a variety of output interfaces 126.

Processes 200 and 300 described below may be implemented in system 100 as described above. A non-transitory computer readable medium may contain instructions that when executed by at least one processor performs the method and operations described at each of the steps in processes 200 and 300. The non-transitory computer readable medium and at least one processor may correspond to one or more of anomaly detection engine 114, controller 112 and memory 120 of anomaly detection system 110 as described above and/or other components of anomaly detection system 110 that may be controlled by controller 112. Processes 200 and 300 may make use of machine learning processes as define herein.

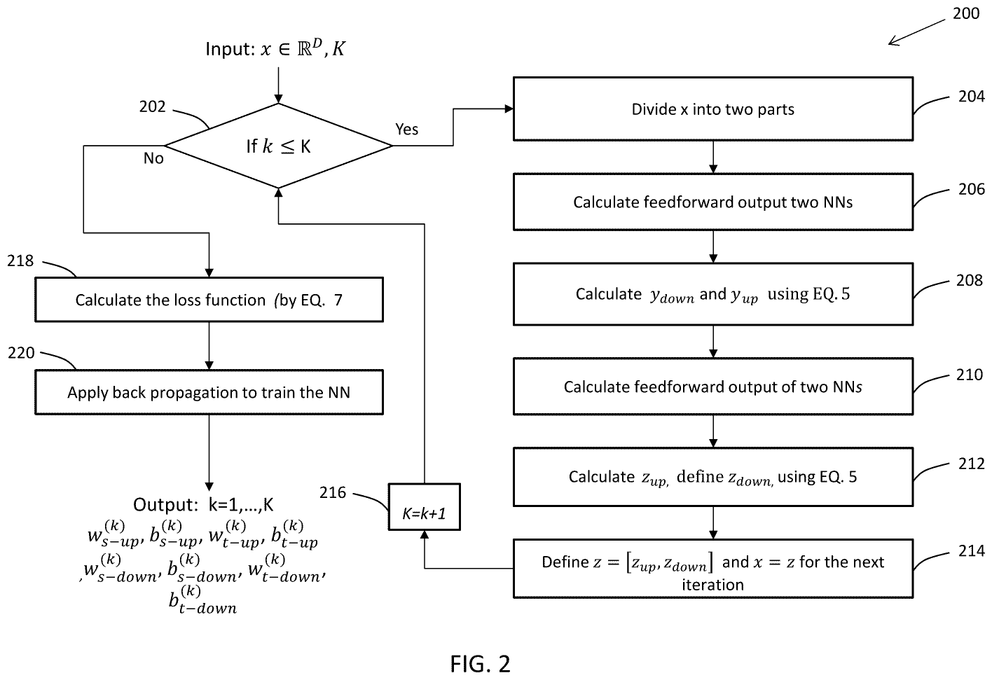

FIG. 2 is a flow diagram of an example process 200 for training input data for derivation of an NF model according to some implementations. As above, to detect anomalies in the data, we can look at it as a way to calculate the likelihood of a sample x without knowing its distribution by calculating the likelihood of z since flows of NF use invertible functions ƒ to map the input data x to a latent representation z.

A flow in NF is a series of transformations applied to datapoints x where ∫p(x)dx=∫q(z)dz=1 (definition of probability distribution) such that p(x)=q(z)|dz/dx|.

Assuming z=ƒ⁻¹(x) then for the 1-dimensional case

$$p ( x ) = q ( {f}^{- 1} ( x ) ) \vert \frac{{df}^{- 1} ( x )}{dx} \vert .$$

For the multivariate case

$$p ( x ) = q ( z ) \vert det ( \frac{dz}{dx} ) \vert = q ( {f}^{- 1} ( x ) ) \vert det ( \frac{{df}^{- 1} ( x )}{dx} ) \vert \qquad ( 1 )$$

By definition, the integral ∫q(z)dz is the sum of an infinite number of rectangles of infinitesimal width Δz. The height of such a rectangle at position z is the value of the density function q(z). Substitution of the variable z=ƒ⁻¹(x) yields

$$\frac{Δ z}{Δ x} = {( {f}^{- 1} ( x ) )}^{′} and Δ z = {( {f}^{- 1} ( x ) )}^{′} Δ x .$$

By applications of k≥1 transformation, EQ. 1 becomes:

$$P ( x ) = q ( {f}_{k}^{- 1} ( {z}_{k - 1} ) ) \cdot q ( {f}_{k - 1}^{- 1} ( {z}_{k - 2} ) ) … {f}_{1}^{- 1} ( {z}_{0} ) {\prod }_{i = 1}^{k} \vert det ( \frac{{df}_{i}^{- 1} ( {z}_{i - 1 )}}{{dz}_{i - 1}} ) \vert$$

where z₀=x. To maximize P(x), log P(x) may be maximized or −log(P(x)) may be minimized,

$$- log ( P ( x ) ) = - log ( q ( {f}_{k}^{- 1} ( {f}_{k - 1}^{- 1} … {f}_{1}^{- 1} ( x ) ) ) ) - {\sum }_{i = 1}^{k} log ( \vert det ( \frac{{df}_{i}^{- 1} ( {z}_{i - 1}}{{dz}_{i - 1}} ) \vert ) .$$

The computation of P(x) requires computation of the determinant of the Jacobian (matrix)

$$( \frac{{df}_{i}^{- 1} ( {z}_{i - 1}}{{dz}_{i - 1}} ) , i = 1 , ... , k . \qquad ( see EQ . 1 )$$

This should be computed efficiently since its computational complexity is O(n³). In addition, the computation of P(x) above is performed for every sample in every iteration and this increases the computational complexity. It is thus desirable to accelerate the computation of the Jacobian since its computational complexity is O(n³) and the computation is performed for every sample in every iteration.

Steps 204-214 provide substantial acceleration of the computation of the Jacobian matrix by calculating only the determinant of the Jacobian and not the Jacobian itself. If the Jacobian is forced to be triangular, then its determinant will be the product of its diagonal terms and this may be accomplished in a computation that is relatively faster than computing the Jacobian itself.

In decision step 202, if k≤K (equivalent to k=k+1≤K) then the process proceeds with step 204. In step 204, to achieve the diagonalization for calculating the determinant, the input data may be divided into two parts: assuming there are D features, define

$${x}_{up} = {x}_{1 : d} \qquad ( 2 )$$

$$and$$

$${x}_{down} = {x}_{( d + 1 ) : D} \qquad ( 3 )$$

where d is an integer such that d<D.

In step 206, two independent neural networks (NN) may be defined for xᵤₚ and the output of each NN will be the size of x_{down}. The output of the first NN may be named s_{down} and the output of the second NN t_{down}. s and t are connected in the following way: in general, the affine transform

$$y = s ⊙ x + t ⇔ x = ( y - t ) ⊙ \frac{1}{s} ,$$

where s and t are learnable by NN, is bijective (represents scaling and shifting) that yields flexible transformation and ⊙ is a Hadamard product.

In this case, in step 208, y_{down}=s_{down}⊙x_{down}+t_{down} may be computed. In step 208 yᵤₚ=xᵤₚ is defined. In step 210, y down may be passed through another two different NNs where the output of each NN may be of the size of xᵤₚ. The output of the first NN may be called Sup and the output of the second NN may be called tᵤₚ. In step 212, zᵤₚ=sᵤₚ⊙yᵤₚ+tᵤₚ may be computed, and z_{down}=y_{down}—may be defined. Finally, in step 214, z may be defined as the concatenation of zᵤₚ and z_{down}.

In steps 206-214, the determinant of the Jacobian is triangular. The definition of the determinant of the Jacobian is:

$$\vert det ( \frac{{df}^{- 1} ( x )}{dx} ) \vert = \vert det ( \begin{matrix}\frac{{df}_{1}^{- 1} ( {x}_{1} )}{{dx}_{1}} & … & \frac{{df}_{1}^{- 1} ( {x}_{1} )}{{dx}_{D}} \\ ⋮ & ⋮ & ⋮ \\ \frac{{df}_{D}^{- 1} ( {x}_{D} )}{{dx}_{1}} & … & \frac{{df}_{D}^{- 1} ( {x}_{D} )}{{dx}_{D}}\end{matrix} ) \vert . \qquad ( 4 )$$

As shown above, the affine cell is yᵤₚ=xᵤₚ. y_{down}=s_{down}⊙x_{down}+t_{down}. For example, assume D=5 and d=2: y_{1:2}=x_{1:2} and y_{3:5}=s_{down}(x₁, x₂)⊙x_{3:5}+t_{down}(x₁, x₂), then EQ. 4 becomes

$$\vert det ( \frac{{df}^{- 1} ( x )}{dx} ) \vert = \vert det ( \begin{matrix}1 & 0 & 0 & 0 & 0 \\ 0 & 1 & 0 & 0 & 0 \\ \frac{{df}_{3}^{- 1} ( {x}_{3} )}{{dx}_{1}} & \frac{{df}_{3}^{- 1} ( {x}_{3} )}{{dx}_{2}} & {s}_{down}^{( 3 )} & 0 & 0 \\ \frac{{df}_{4}^{- 1} ( {x}_{4} )}{{dx}_{1}} & \frac{{df}_{4}^{- 1} ( {x}_{4} )}{{dx}_{2}} & 0 & {s}_{down}^{( 4 )} & 0 \\ \frac{{df}_{5}^{- 1} ( {x}_{5} )}{{dx}_{1}} & \frac{{df}_{5}^{- 1} ( {x}_{5} )}{{dx}_{2}} & 0 & 0 & {s}_{down}^{( 5 )}\end{matrix} ) \vert = \vert {\prod }_{i = 3}^{5} {s}_{down}^{( i )} \vert \qquad ( 5 )$$

which has a triangular structure and its computation is faster (as described above) since it is the product of the diagonal terms.
−log(P(x)) is calculated by −log|Πᵢ₌₃⁵s_{down}⁽ⁱ⁾|=−Σᵢ₌₃⁵ log(s_{down}⁽ⁱ⁾).

By following the same procedure for sᵤₚ⁽ⁱ⁾ we get −log|Πᵢ₌₁²sᵤₚ⁽ⁱ⁾|=−Σᵢ₌₁² log(sᵤₚ⁽ⁱ⁾). Overall loss is

$$- log ( P ( x ) ) = - log ( q ( z ) ) - {\sum }_{i = 3}^{5} log ( {s}_{down}^{( i )} ) - {\sum }_{i = 1}^{2} log ( {s}_{up}^{( i )} ) .$$

This procedure may be repeated again and again (steps 204-214) and we define

$$log ( {s}^{k} ) = {\sum }_{i = 3}^{5} log ( {s}_{down}^{( i )} ) + {\sum }_{i = 1}^{2} log ( {s}_{up}^{( i )} ) .$$

In a general form, we get

$$log ( {s}^{k} ) = {\sum }_{i = \frac{d}{2} + 1}^{D} log ( {s}_{down}^{( i )} ) + {\sum }_{i = 1}^{\frac{d}{2}} log ( {s}_{up}^{( i )} ) . \qquad ( 6 )$$

P(x) is the likelihood and as such, it has no upper bound, unlike probability that is bounded by 1. The loss is:

$$Loss = - log ( P ( x ) ) = - log ( q ( z ) ) - {\sum }_{k} log ( {s}^{k} ) \qquad ( 7 )$$

and because P(x) has no upper bound, the loss may be negative which is allowable.

z and x are defined in step 214 and they will be the input to the next iteration (steps 204-214) after k is increased by 1 (step 216) and decision step 202 is ‘yes’. If decision step 202 is ‘no’ then step 218 takes place.

Any NN can be used. s^{k} is defined by EQ. 6—step 218. Only z and the trained NN are required to reconstruct x from z or to generate a new sample from q(z) since it is a generative model: since z_{down}=y_{down}, calculate sᵤₚ and tᵤₚ and use the inverse transformation to calculate yᵤₚ (which is equal to xᵤₚ) and then use it to calculate s_{down} and t_{down} in order to calculate x_{down}.

The complete training phase is provided in process 200. Since process 200 is iterative, a running variable k may be added as a power for each variable including the variables s and t that are described above. The output of process 200 for k=1, . . . , K is

$$\{ ( {w}_{s - up}^{( k )} , {b}_{s - up}^{( k )} ) , ( {w}_{t - up}^{( k )} , {b}_{t - up}^{( k )} ) , ( {w}_{s - down}^{( k )} , {b}_{s - down}^{( k )} ) , ( {w}_{t - down}^{( k )} , {b}_{t - down}^{( k )} ) \}$$

Process 200 may be summarized as follows:

```
  Input: x∈ [symbol]  ^{D} may be a single data sample (or may be a batch), K is the number of
affine cells that the process uses
  Output: for k = 1, . . . , K {(wₛ₋ᵤₚ^{(k)}xᵤₚ, bₛ₋ᵤₚ^{(k)}), (wₜ₋ᵤₚ^{(k)}xᵤₚ, bₜ₋ᵤₚ^{(k)}), (w_{s-down}^{(k)}y_{down}, b_{s-down}^{(k)}),
(w_{t-down}^{(k)}y_{down}, b_{t-down}^{(k)})}
1.  for k = 1 to K or k ≤ K step 202
2.  Divide x into xᵤₚ and x_{down} according to EQS. 2 & 3 where d can be any integer such
      $that d < D . The standard choice is d = \frac{D}{2} . step 204$
3.  Calculate the feed forward output of two independent NNs: s_{down}^{(k)} = tanh(wₛ₋ᵤₚ^{(k)}xᵤₚ +
    bₛ₋ᵤₚ^{(k)}) and t_{down}^{(k)} = tanh (wₜ₋ᵤₚ^{(k)}xᵤₚ + bₜ₋ᵤₚ^{(k)}) where b is a bias and w are weights of the
    NN step 206
4.  Calculate y_{down} = s_{down}^{(k)} ⊙ x_{down} + t_{down}^{(k)} and define yᵤₚ = xᵤₚ (using EQ. 5) step 208
5.  Calculate the feed forward output of two independent NNs: sᵤₚ^{(k)} = tanh(w_{s-down}^{(k)}y_{down} +
    b_{s-down}^{(k)}) and tᵤₚ^{(k)} = tanh(w_{t-down}^{(k)}y_{down} + b_{t-down}^{(k)})  step 210
6.  Calculate zᵤₚ = sᵤₚ^{(k)} ⊙ yᵤₚ + tᵤₚ^{(k)} and define z_{down} = y_{down} (using EQ. 5) step 212
7.  Define z = [zᵤₚ, z_{down}] and x = z for the next iteration step 214
  End, increase K = k + 1 step 216
8.  Calculate the loss function EQ. 7 where usually q(z)~N(0,1) step 218
9.  Apply back propagation to train the weights and biases of the NN step 220
10.  Output: for k = 1, . . . , K
      {(wₛ₋ᵤₚ^{(k)}, bₛ₋ᵤₚ^{(k)}), (wₜ₋ᵤₚ^{(k)}bₜ₋ᵤₚ^{(k)}), (w_{s-down}^{(k)}, b_{s-down}^{(k)}), (w_{t-down}^{(k)}, b_{t-down}^{(k)})}
```

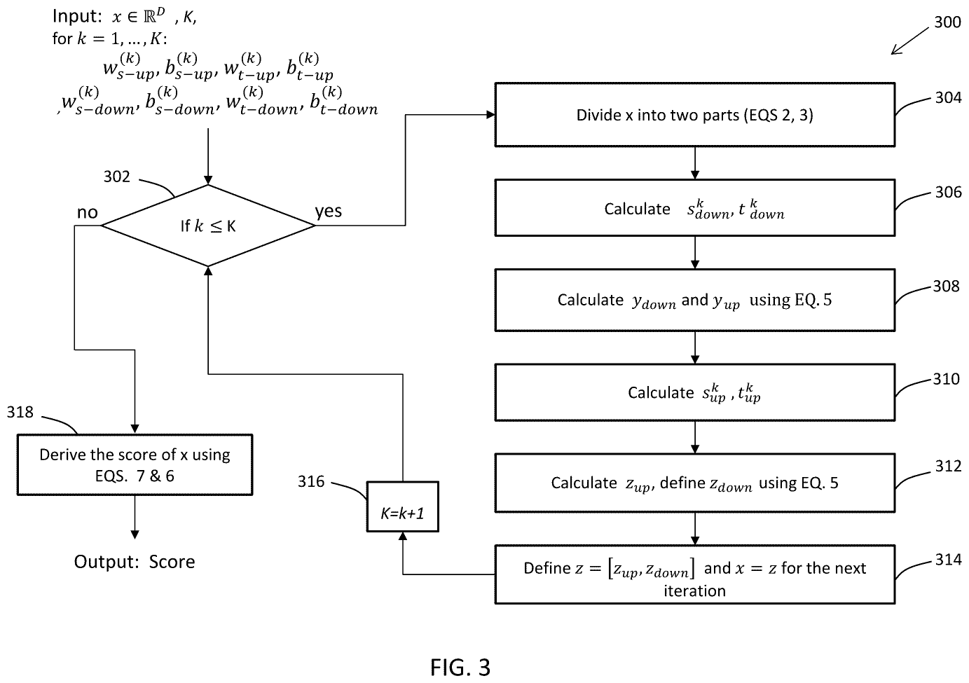

FIG. 3 is a flow diagram of an example process 300 for derivation of a scoring function and use of the scoring function for anomaly detection according to some implementations. The detection phase may be achieved by process 200. Process 300 has the same flow as process 200 except that the NNs from process 200 are not used. Only their computed weights and biases from process 200 are transferred to process 300 and are used for the score computation.

The inputs to process 300 are vectors of length K (k=1, . . . , k) that include weights and biases (wₛ₋ᵤₚ^{(k)}, bₛ₋ᵤₚ^{(k)}) and (wₜ₋ᵤₚ^{(k)}, bₜ₋ᵤₚ^{(k)}) computed in step 206 and (w_{s-down}^{(k)}, b_{s-down}^{(k)}), (w_{t-down}^{(k)}, b_{s-down}^{(k)}) computed in step 210.

In decision step 302, if k≤K, then the process proceeds with step 304.

In step 304, the sample x, whose score is computed in process 300, is divided into two parts xᵤₚ and x_{down} according to EQS. 2 & 3 as was done in step 204. In step 306, s_{down}^{(k)} and t_{down}^{(k)} are computed (in an NN) by using the input of weights and biases.

In step 308, y_{down} and yᵤₚ are computed using EQ. 5. In step 310, sᵤₚ^{(k)} and tᵤₚ^{(k)} are computed. In step 312, z is computed using EQ. 5. z and x are defined in step 314 and they will be the input to the next iteration (steps 304-314) after k is increased by 1 (step 316) and step 302 is ‘yes’. If it is ‘no’ then step 318 takes place.

In step 318, the loss function, which provides the desired score for the datapoint, is generated by the above components (s_{down′}^{(k)}) and sᵤₚ^{(k)} as described in EQ. 7 that uses EQ. 6.

Process 300 may be summarized as follows:

Input: x ∈ [symbol] ^{D} is a single data sample (it may also be a batch), K is the number of affine

cells that the algorithm uses, for k = 1, ... , K,{(wₛ₋ᵤₚ^{(k)}, bₛ₋ᵤₚ^{(k)}), (wₜ₋ᵤₚ^{(k)}, bₜ₋ᵤₚ^{(k)}),
(w_{s-down}^{(k)}, b_{s-down}^{(k)}), (w_{t-down}^{(k)}, b_{t-down}^{(k)})}

| | |
|---|---|
| | Output: score function for each x |
| 1. | for k = 1, ... , K or k ≤ K step 302 |
| 2. | Divide x into xᵤₚ and x_{down} according to EQS. 2 & 3 as was done in process 200, step |
| | 304 |
| 3. | Calculate s_{down}^{(k)} =tanh(wₛ₋ᵤₚ^{(k)}xᵤₚ + bₛ₋ᵤₚ^{(k)}) and t_{down}^{(k)}=tanh(wₜ₋ᵤₚ^{(k)}xᵤₚ + bₜ₋ᵤₚ^{(k)}) where w |
| | are the weights and b is the bias of the NNs that were computed in process 200 step 306 |
| 4. | Calculate y_{down} = s_{down}^{(k)} ⊙ x_{down} + t_{down}^{(k)} and define yᵤₚ = xᵤₚ (using EQ. 5) step |
| | 308 |
| 5. | Calculate sᵤₚ^{(k)}=tanh(w_{s-down}^{(k)}y_{down} + b_{s-down}^{(k)}) and tᵤₚ^{(k)}=tanh(w_{t-down}^{(k)}y_{down} + |
| | b_{t-down}^{(k)}) where w are the weights and b is the bias of the NNs that were computed in |
| | process 200 step 310 |
| 6. | Calculate zᵤₚ = sᵤₚ^{(k)} ⊙ yᵤₚ + tᵤₚ^{(k)} and define z_{down} = y_{down} (by EQ. 5) step 312 |
| 7. | Define z = [zᵤₚ, z_{down}] and x = z for the next iteration step 314 |

end K=k+1 step 316

| | |
|---|---|
| 8. | Calculate the loss function EQ. 7 using EQ. 6 to generate the score = −log(q(z))− |
| | Σₖ log(s^{k}) step 318 |

The score output of process 300 may be used to determine whether the MDDP may be an anomaly. When the MDDP is classified as an anomaly, one or more of triggering an alarm or sending a notification to a user or a data client system may be performed. Classification of the MDDP as an anomaly may be indicative of detection of an unknown undesirable event.

Unless otherwise defined, all technical and scientific terms used herein have the same meaning as commonly understood by one of ordinary skill in the art. The materials, methods, and examples provided herein are illustrative only and not intended to be limiting.

As used herein the terms “machine learning” or “artificial intelligence” refer to use of algorithms on a computing device that parse data, learn from the data, and then make a determination or generate data, where the determination or generated data is not deterministically replicable (such as with deterministically oriented software as known in the art).

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a chip or a circuit. As software or algorithm, selected steps of the disclosure could be implemented as a plurality of software instructions being executed by a computer using any suitable operating system. In any case, selected steps of the method and system of the disclosure could be described as being performed by a data processor, such as a computing device for executing a plurality of instructions.

Although the present disclosure is described with regard to a “computing device”, a “computer”, or “mobile device”, it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may form a “network” or a “computer network”.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.t

In some embodiments, the anomaly detection system may be implemented on one or more servers or storage systems and/or services associated with a business or corporate entity, including for example, a file hosting service, cloud storage service, a hardware server, a virtual server, an online file storage provider, a peer-to-peer file storage or hosting service and/or a cyber locker. In some embodiments, the anomaly detection system may be provided in various deployments models including but not limited to cloud based, hardware server, or virtual.

Memory (such as memory 120) may include one or more types of computer-readable storage media including, for example, transactional memory and/or long-term storage memory facilities and may function as file storage, document storage, program storage, and/or as a working memory. The latter may, for example, be in the form of a static random-access memory (SRAM), dynamic random-access memory (DRAM), read-only memory (ROM), cache or flash memory. As long-term memory, memory may, for example, include a volatile or non-volatile computer storage medium, a hard disk drive, a solid-state drive, a magnetic storage medium, a flash memory and/or other storage facility. A hardware memory facility may, for example, store a fixed information set (e.g., software code) including, but not limited to, a file, program, application, source code, object code and the like.

In some embodiments, some implementations and/or portions and/or processes and/or elements and/or functions of the anomaly detection engine may be implemented within output interface and/or data client systems. Hence, in some embodiments, output interface and/or data client systems for example may be considered be part of anomaly detection system.

In some embodiments, machine learning algorithms (also referred to as machine learning models or artificial intelligence in the present disclosure) may be trained using training examples, for example in the processes described herein. Some non-limiting examples of such machine learning algorithms may include classification algorithms, data regressions algorithms, image segmentation algorithms, mathematical embedding algorithms, support vector machines, random forests, nearest neighbors algorithms, deep learning algorithms, artificial neural network algorithms, convolutional neural network algorithms, recursive neural network algorithms, linear machine learning models, non-linear machine learning models, ensemble algorithms, and so forth. For example, a trained machine learning algorithm may comprise an inference model, such as a predictive model, a classification model, a regression model, a clustering model, a segmentation model, an artificial neural network (such as a deep neural network, a convolutional neural network, a recursive neural network, etc.), a random forest, a support vector machine, and so forth. In some examples, the training examples may include example inputs together with the desired outputs corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. In some examples, a machine learning algorithm may have parameters and hyper parameters, where the hyper parameters are set manually by a person or automatically by a process external to the machine learning algorithm (such as a hyper parameter search algorithm), and the parameters of the machine learning algorithm are set by the machine learning algorithm according to the training examples. In some implementations, the hyper-parameters are set according to the training examples and the validation examples, and the parameters are set according to the training examples and the selected hyper-parameters.

While certain steps methods are outlined herein as being executed by a specific module and other steps by another module, this should by no means be construed limiting.

It should be understood that where the claims or specification refer to “a” or “an” element, such reference is not to be construed as there being only one of that element. In the description and claims of the present application, each of the verbs, “comprise” “include” and “have”, and conjugates thereof, are used to indicate that the object or objects of the verb are not necessarily a complete listing of components, elements or parts of the subject or subjects of the verb.

While this disclosure describes a limited number of embodiments, it will be appreciated that many variations, modifications and other applications of such embodiments may be made. The disclosure is to be understood as not limited by the specific embodiments described herein, but only by the scope of the appended claims.

What is claimed is:

1. A computer program product, comprising: a non-transitory tangible storage medium readable by a processing circuit and storing instructions for execution by the processing circuit for performing a method comprising: receiving input data including a multidimensional data point (MDDP), deriving a scoring function using normalizing flows (NF), and using the scoring function to provide a probability of whether the MDDP is normal or is an anomaly.

2. The computer program product of claim 1, wherein the deriving includes computation of a Jacobian matrix and the computation is accelerated by calculating only the determinant of the Jacobian matrix including forcing the Jacobian to be triangular.

3. The computer program product of claim 1, wherein the deriving a scoring function includes a training phase, wherein, for a data sample x and K affine cells, the training phase includes: for k=1 to K or k≤K iterations: dividing x into xᵤₚ and x_{down}; calculating the feed forward output of a first two independent neural networks (NNs) s_{down}^{(k)}=tanh(wₛ₋ᵤₚ^{(k)}xᵤₚ+bₛ₋ᵤₚ^{(k)}) and t_{down}^{(k)}=tanh(wₜ₋ᵤₚ^{(k)}xᵤₚ+bₜ₋ᵤₚ^{(k)}) where b and w are the first biases and weights of the first two independent NNs; calculating y_{down}=s_{down}^{(k)}⊙x_{down}+t_{down}^{(k)} and defining yᵤₚ=xᵤₚ; calculating a feed forward output of a second two independent NNs sᵤₚ^{(k)}=tanh(w_{s-down}^{(k)}y_{down}+b_{s-down}^{(k)}) and tᵤₚ^{(k)}=tanh(w_{t-down}^{(k)}y_{down}+b_{t-down}^{(k)}); calculating zᵤₚ=sᵤₚ^{(k)}⊙yᵤₚ +tᵤₚ^{(k)}; defining z_{down}=y_{down}; defining z=[zᵤₚ, z_{down}] and x=z for the next iteration; and incrementing K=k+1, wherein for k=K: calculating a loss function of the NNs; and applying back propagation to train the weights and biases of the NNs.

4. The computer program product of claim 1, wherein the deriving a scoring function includes, using an output of the training phase and the MDDP (x_{MDDP}) as inputs: for k=1 to K or k≤K iterations: dividing x_{MDDP} into xᵤₚ and x_{down}; calculating s_down and t_down according to s_{down}^{(k)}=tanh(wₛ₋ᵤₚ^{(k)}xᵤₚ+bₛ₋ᵤₚ^{(k)}) and t_{down}^{(k)}=tan(wₜ₋ᵤₚ^{(k)}xᵤₚ+bₜ₋ᵤₚ^{(k)}) using b and w determined in the training phase; calculating y_{down}=s_{down}^{(k)}⊙x_{down}+t_{down}^{(k)}; defining yᵤₚ=xᵤₚ; calculating sᵤₚ^{(k)}=tanh(w_{s-down}^{(k)}y_{down}+b_{s-down}^{(k)}) and tᵤₚ^{(k)}=tanh(w_{t-down}^{(k)}y_{down}+b_{t-down}^{(k)}) using b and w determined in the training phase; calculating zᵤₚ=sᵤₚ^{(k)}⊙yᵤₚ+tᵤₚ^{(k)}; defining z_{down}=y_{down}; defining x=z for the next iteration; incrementing K=k+1, wherein for k=K: calculating a loss function to generate a score for the MDDP.

5. The computer program product of claim 4, wherein the returned score is used to determine whether the MDDP is normal or is an anomaly.

6. The computer program product of claim 5, the method further comprising: when the MDDP is classified as an anomaly, performing one or more of triggering an alarm, and sending a notification to a user or a data client system, wherein classification of the MDDP as an anomaly is indicative of detection of an unknown undesirable event.

7. A computer system, comprising: a hardware processor configurable to perform a method comprising: receiving input data including a multidimensional data point (MDDP), deriving a scoring function using normalizing flows (NF), and using the scoring function to provide a probability of whether the MDDP is normal or is an anomaly.

8. The computer system of claim 7, wherein the deriving includes computation of a Jacobian matrix and the computation is accelerated by calculating only the determinant of the Jacobian matrix including forcing the Jacobian to be triangular.

9. The computer system of claim 7, wherein the deriving a scoring function includes a training phase, wherein, for a data sample x and K affine cells, the training phase includes: for k=1 to K or k≤K iterations: dividing x into xᵤₚ and x_{down}; calculating the feed forward output of a first two independent neural networks (NNs) s_{down}^{(k)}=tanh(wₛ₋ᵤₚ^{(k)}xᵤₚ+bₛ₋ᵤₚ^{(k)}) and t_{down}^{(k)}=tanh(wₜ₋ᵤₚ^{(k)}xᵤₚ+bₜ₋ᵤₚ^{(k)}) where b and w are the first biases and weights of the first two independent NNs; calculating y_{down}=s_{down}^{(k)}⊙x_{down}+t_{down}^{(k)} and defining yᵤₚ=xᵤₚ; calculating a feed forward output of a second two independent NNs sᵤₚ^{(k)}=tanh(w_{s-down}^{(k)}y_{down}+b_{s-down}^{(k)}) and tᵤₚ^{(k)}=tanh(w_{t-down}^{(k)}y_{down}+b_{t-down}^{(k)}); calculating zᵤₚ=sᵤₚ^{(k)}⊙yᵤₚ+tᵤₚ+tᵤₚ^{(k)}; defining z_{down}=y_{down}; defining z=[zᵤₚ, z_{down}] and x=z for the next iteration; and incrementing K=k+1, wherein for k=K: calculating a loss function of the NNs; and applying back propagation to train the weights and biases of the NNs.

10. The computer system of claim 9, wherein the deriving a scoring function includes, using an output of the training phase and the MDDP (x_{MDDP}) as inputs: for k=1 to K or k≤K iterations: dividing x_{MDDP} into xᵤₚ and x_{down}; calculating s_down and t_down according to s_{down}^{(k)}=tanh(wₛ₋ᵤₚ^{(k)}xᵤₚ+bₛ₋ᵤₚ^{(k)}) and t_{down}^{(k)}=tanh(wₜ₋ᵤₚ^{(k)}xᵤₚ+bₜ₋ᵤₚ^{(k)}) using b and w determined in the training phase; calculating y_{down}=s_{down}^{(k)}⊙x_{down}+t_{down}^{(k)}; defining yᵤₚ=xᵤₚ; calculating sᵤₚ^{(k)}=tanh(w_{s-down}^{(k)}y_{down}+b_{s-down}^{(k)}) and tᵤₚ^{(k)}=tanh(w_{t-down}^{(k)}y_{down}+b_{t-down}^{(k)}), using b and w determined in the training phase; calculating zᵤₚ=sᵤₚ^{(k)}⊙yᵤₚ+tᵤₚ^{(k)}; defining z_{down}=y_{down}; defining x=z for the next iteration; incrementing K=k+1, wherein for k=K: calculating a loss function to generate a score for the MDDP.

11. The computer system of claim 10, wherein the returned score is used to determine whether the MDDP is normal or is an anomaly.

12. The computer system of claim 11, the method further comprising: when the MDDP is classified as an anomaly, performing one or more of triggering an alarm, and sending a notification to a user or a data client system, wherein classification of the MDDP as an anomaly is indicative of detection of an unknown undesirable event.

13. A method comprising: receiving input data including a multidimensional data point (MDDP); deriving a scoring function using normalizing flows (NF); and using the scoring function to provide a probability of whether the MDDP is normal or is an anomaly.

14. The method of claim 13, wherein the deriving includes computation of a Jacobian matrix and the computation is accelerated by calculating only the determinant of the Jacobian matrix including forcing the Jacobian to be triangular.

15. The method of claim 13, wherein the deriving a scoring function includes a training phase, wherein, for a data sample x and K affine cells, the training phase includes: for k=1 to K or k≤K iterations: dividing x into xᵤₚ and x_{down}; calculating the feed forward output of a first two independent neural networks (NNs) (k) s_{down}^{(k)}=tanh(wₛ₋ᵤₚ^{(k)}xᵤₚ+bₛ₋ᵤₚ^{(k)}) and t_{down}^{(k)}=tanh(wₜ₋ᵤₚ^{(k)}xᵤₚ+bₜ₋ᵤₚ^{(k)}) where b and w are the first biases and weights of the first two independent NNs; calculating y_{down}=s_{down}^{(k)}⊙x_{down}+t_{down}^{(k)} and defining yᵤₚ=xᵤₚ; calculating a feed forward output of a second two independent NNS sᵤₚ^{(k)}=tanh(w_{s-down}^{(k)}y_{down}+b_{s-down}^{(k)}) and tᵤₚ^{(k)}32 tanh(w_{t-down}^{(k)}y_{down}+b_{t-down}^{(k)}); calculating zᵤₚ=sᵤₚ^{(k)}⊙yᵤₚ+tᵤₚ^{(k)}; defining z_{down}=y_{down}; defining z=[zᵤₚ, z_{down}] and x=z for the next iteration; and incrementing K=k+1, wherein for k=K: calculating a loss function of the NNs; and applying back propagation to train the weights and biases of the NNs.

16. The method of claim 15, wherein the deriving a scoring function includes, using an output of the training phase and the MDDP (x_{MDDP}) as inputs: for k=1 to K or k≤K iterations: dividing x_{MDDP} into xᵤₚ and x_{down}; calculating s_down and t_down according to s_{down}^{(k)}=tanh(wₛ₋ᵤₚ^{(k)}xᵤₚ+bₛ₋ᵤₚ^{(k)}) and t_{down}^{(k)}=tanh(wₜ₋ᵤₚ^{(k)}xᵤₚ+bₜ₋ᵤₚ^{(k)}) using b and w determined in the training phase; calculating y_{down}=s_{down}^{(k)}⊙x_{down}+t_{down}^{(k)}; defining yᵤₚ=xᵤₚ; calculating sᵤₚ^{(k)}=tanh(w_{s-down}^{(k)}y_{down}+b_{s-down}^{(k)}) and tᵤₚ^{(k)}=tanh(w_{t-down}^{(k)}y_{down}(k)+b_{t-down}^{(k)}) using b and w determined in the training phase; calculating zᵤₚ=sᵤₚ^{(k)}⊙yᵤₚ+tᵤₚ^{(k)}; defining z_{down}=y_{down}; defining x=z for the next iteration; incrementing K=k+1, wherein for k=K: calculating a loss function to generate a score for the MDDP.

17. The method of claim 16, wherein the returned score is used to determine whether the MDDP is normal or is an anomaly.

18. The method of claim 17 further comprising: when the MDDP is classified as an anomaly, performing one or more of triggering an alarm, and sending a notification to a user or a data client system, wherein classification of the MDDP as an anomaly is indicative of detection of an unknown undesirable event.
